(19) United States
(12) Patent Application Publication
(10) Pub. No.: US 2025/0231545 A1
(43) Pub. Date: Jul. 17, 2025

(54) MANUFACTURING TOOL

(71) Applicant: Matuschek Messtechnik GmbH, Alsdorf (DE)

(72) Inventors: Christoph Pierednik, Aachen (DE); Axel Heinemann, Aachen (DE)

(73) Assignee: Matuschek Messtechnik GmbH, Alsdorf (DE)

(21) Appl. No.: 18/837,907

(22) PCT Filed: Feb. 3, 2023
(86) PCT No.: PCT/EP2023/052667

§ 371 Date: Apr. 8, 2025

(30) Foreign Application Priority Data
Feb. 16, 2022 (DE) 10 2022 103 639.1

(51) Int. Cl. G05B 19/19; B25J 15/00

(52) U.S. Cl. CPC G05B 19/19; B25J 15/0019

(57) ABSTRACT

A manufacturing tool has a mounting element for mounting to a positioning device. A multi-axis robot arm is attached to the manufacturing tool in order to further develop the manufacturing tool for optimum performance of a manufacturing task. The positioning device may be an industrial robot. The manufacturing tool may be a Welding gun, a Soldering tool, Riveting pliers, or a Screwing tool. The manufacturing tool may be coupled to at least one numerical control unit which controls the manufacturing tool, the multi-axis robot arm, and/or the positioning device. The numerical control unit may be arranged remotely from the manufacturing tool and may have data links that transmit control signals. The manufacturing tool may include a manipulator that is attached to the multi-axis robot arm and/or may include a holding device that holds at least one component.

### TECHNICAL FIELD

This application relates to a manufacturing tool with a mounting element for mounting on a positioning device and, more particularly to a manufacturing tool with a mounting element for mounting on a positioning device and with a joining tool.

### BACKGROUND

Welding guns are tools for resistance welding that are used on a large scale and in a wide variety of designs in industrial manufacturing processes. In particular, spot welding is known from the production of car bodies, in which at least two metal sheets are clamped between two welding electrodes of a welding gun, pressed against one another, and spot-welded together using a welding current. Welding processes can be carried out with a high degree of automation. Welding guns usually have a mounting plate for mounting to an industrial robot. The industrial robot is usually a six-axis robot arm that can position the welding gun in any position within its range of action. In modern car body production plants, a large number of such welding guns are used on different robot arms. Various types of welding guns can be found in the applicant's patent document DE 102 23 821 A1. Document U.S. Pat. No. 8,661,926 B2 shows in FIG. 5 a workstation for simultaneous welding with five welding guns. Five six-axis robot arms each carry a welding gun, which produce welds in the upper or lower area of the car body.

Combinations of a large number of multi-axis robot arms, each of which carries a manufacturing tool, are also known from medical technology. One such arrangement is shown in US 2021/0330403 A1, for example. From the publication “Toward site-specific and self-sufficient robotic fabrication on architectural scales” by Keating et al, Sci. Robot. 2, eaam8986 (2017) of Apr. 26, 2017, it is known to attach a second multi-axis robot arm to the end of a manipulation robot arm that can be moved with a chassis. An excavator bucket can additionally be attached to the end of the manipulation robot arm. DE 10 2013 227 132 B3 discloses a welding device for welding a welding element onto a workpiece, the welding device having an integrated holder for the welding element. U.S. Pat. No. 4,568,816 A describes a robot arm to which a module with a welding gun, monitoring camera and grid projection unit is attached.

### SUMMARY OF THE INVENTION

It is desirable to further develop a manufacturing tool for optimally performing manufacturing tasks.

According to the system described herein, a multi-axis robot arm is attached to the manufacturing tool.

In other words, it is proposed to attach a robot arm to the tool itself, which can assist the tool during use. The robot arm may be attached to the mounting element as well as to any other load-bearing sections of the manufacturing tool. In particular, a six-axis robot arm may be attached to the manufacturing tool. A six-axis robot arm has optimum freedom of movement and is enabled to reach substantially any location within a reach of the robot arm. The robot arm is spatially fixedly associated with the manufacturing tool to which the robot arm is attached. The attachment location on the manufacturing tool may be optimally selected so that the robot arm is in an optimum position for assisting the manufacturing tool. Due to the fixed association of the robot arm with the manufacturing tool, tool change requires minimal effort because the robot arm is attached to the positioning device and also detached again together with the manufacturing tool. In addition, the fixed spatial association minimizes the effort required to program the movement sequences of the robot arm. For example, in the event of a tool change, new programming is not required because the position of the robot arm in relation to the manufacturing tool remains unchanged and the programming of the robot arm movement may remain unchanged.

In practice, a manipulator may be arranged at a free end of the multi-axis robot arm. For example, the manipulator may be a gripper that feeds parts to the manufacturing tool. Welding guns are often used to weld metallic components to workpieces, e.g. car body panels. For example, nuts with internal threads or sheet metal washers may be welded. Similar joining work may be carried out with soldering tools when assembling circuit boards. If a robot arm with a manipulator is attached directly to the manufacturing tool, the robot arm can reliably bring components to be fastened into a predetermined position and hold the components while the manufacturing tool is active (e.g., in the case of a welding gun, performing a weld).

However, other devices may also be attached to the multi-axis robot arm. For example, an ultrasonic probe may be attached which is used to check the welding quality. Furthermore, a camera or a pyrometer may be arranged in order to check, monitor or even control the welding. Any devices that are suitable for supporting, monitoring or controlling the manufacturing process carried out by the manufacturing tool may be brought into the predetermined position by the robot arm.

It is mentioned above that the manufacturing tool may be a welding gun or a soldering tool. Furthermore, riveting pliers or screwing tools are manufacturing tools that are suitable for joining components. The multi-axis robot arm may be attached to such manufacturing tools or to the housings of the manufacturing tools. However, the invention is not limited to such joining tools. In principle, the robot arm may be attached to any tool used for manufacturing such as tools that supply a material or a component or tools that supply operating fluids (air, coolant) during manufacturing or tools that require the detection of signals by a camera or another sensor during manufacturing.

In practice, the positioning device for the manufacturing tool may be an industrial robot. In the arrangement of the multi-axis robot arm on a welding gun described herein, the welding gun may be mounted on an industrial robot using a mounting plate of the welding gun. The industrial robot may have a multi-axis, in particular a six-axis, robot arm, where the mounting plate is screwed to the free end of the arm. However, the manufacturing tool may also be mounted with a mounting element on any other suitable positioning device that can reliably move the manufacturing tool into the predetermined processing position.

In practice, the manufacturing tool may be coupled to at least one numerical control unit that controls at least one of the following:
the manufacturing tool;
the multi-axis robot arm;
the positioning device.

In the welding gun application described above, a high degree of automation is usually desired. In this case, both the industrial robot on which the welding gun is mounted and the welding gun itself are numerically controlled. It is possible to provide an integrated control unit that controls both the welding gun and the industrial robot. In practice, however, the control of the positioning by the industrial robot is usually separated from the control of the welding gun. The control units may be linked to each other via data links. The term ‘data link’ includes analog, digital, wired and wireless signal transmission channels. When the positioning device has reached the processing position, the positioning device sends a signal to the control unit of the welding gun, which then carries out the welding, i.e., the control unit closes the welding electrodes and conducts the welding current to the welding electrodes.

When the welding process is complete, the control unit of the welding gun sends a signal to the control unit of the industrial robot, which, according to a predetermined program, either moves the welding gun away from the workpiece to be processed so that the workpiece may be transported further, or moves the welding gun to another processing position on the workpiece where a further weld is performed.

The control of the multi-axis robot arm may also be effectively decoupled from the control of the manufacturing tool (welding gun) and the positioning device (industrial robot). However, the multi-axis robot arm may be controlled by the same control unit as the manufacturing tool. The multi-axis robot arm is attached to the manufacturing tool and is used to support the manufacturing process by the manufacturing tool, so that functions of the multi-axis robot arm are preferably also controlled by the same control unit for the manufacturing tool. The movements of the multi-axis robot arm are an essential part of the manufacturing process and are synchronized with the functional sequence of the manufacturing tool by the common control unit. The numerical control units may be arranged remotely from the manufacturing tool and have data links for transmitting the control signals. This is particularly advantageous if the manufacturing tool is a welding gun. The direct environment of a welding gun is not recommended for numerical control units due to the high temperatures and high welding currents. In practice, the control units are arranged in control cabinets and linked to the devices to be controlled via data links.

In practice, the manufacturing tool may have at least one holding device for at least one component. Such a holding device can be used to attach several components to the manufacturing tool, which may then be installed in one manufacturing process. For example, a welding gun may be used to weld a weld nut to a car body at each of four different locations. In this case, it is advantageous that a holding device for at least four weld nuts is attached to the manufacturing tool itself. The holding device may be realized in various ways. For example, simple holding bolts, possibly in combination with a magnetic plate, may be attached to the housing of a welding gun as a holding device. The welding gun may then be moved back into a rest position by the positioning device when the processing of a first workpiece has been completed and a second workpiece is transported into the processing position. At least one supply point for components to be fastened (e.g., weld nuts) may be provided in the vicinity of a rest position. During the change of workpieces, the gripper can repeatedly grip a weld nut at the supply point and transport the weld nut to the holding device. After the gripper has gripped the number of components required for the next manufacturing process and attached the components to the holding device, the welding gun with the holding device and the robot arm may be transported to the processing position for the next manufacturing process. In this way, it is avoided that the manufacturing tool has to be moved several times during the processing of one workpiece in order to feed further components to the robot arm.

Alternatively, the components to be mounted or other material required for processing may be fed via feed lines to the manufacturing tool (welding gun).

The system described herein further relates to a method for joining a component using a manufacturing tool having a mounting element which is mounted to a positioning device, where the manufacturing tool is moved into the processing position using the positioning device.

To optimize processing by the manufacturing tool, a multi-axis robot arm attached to the manufacturing tool moves the component into the joining position, whereupon the manufacturing tool fastens the component.

As mentioned above, the robot arm may remove the component from a holding device attached to the joining tool. The robot arm may also remove the component from a supply and attach the component to the holding device before the manufacturing tool is moved by the positioning device to the processing position on the workpiece to be processed.

The robot arm may also remove the component from a supply and attach the component to the holding device before the manufacturing tool is moved to the workpiece to be processed by the positioning device.

### BRIEF DESCRIPTION OF DRAWINGS

Embodiments of the system are described with reference to the several figures of the drawings, noted as follows.

FIG. 1 shows a three-dimensional view of a welding gun, according to the system described herein, mounted on the last link of a robot arm.

FIG. 2 shows a side view of an industrial robot with a welding gun according to the system described herein.

FIG. 3 shows a three-dimensional view of the industrial robot with a welding gun during operation according to the system described herein.

FIG. 4 schematically shows control units for an industrial robot with a welding gun according to the system described herein.

### DESCRIPTION OF VARIOUS EMBODIMENTS

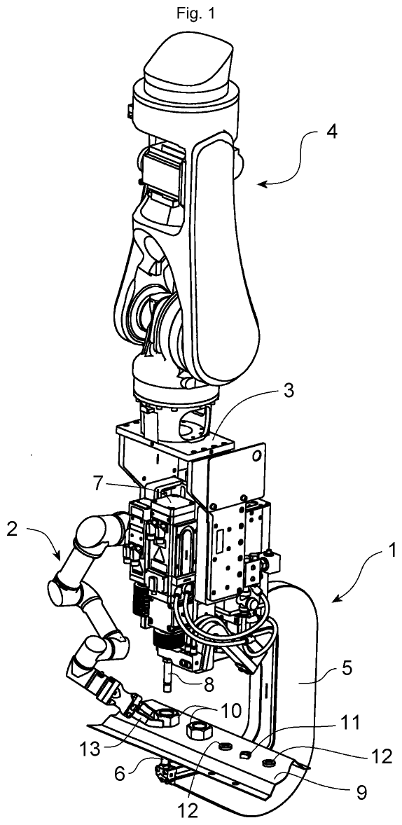

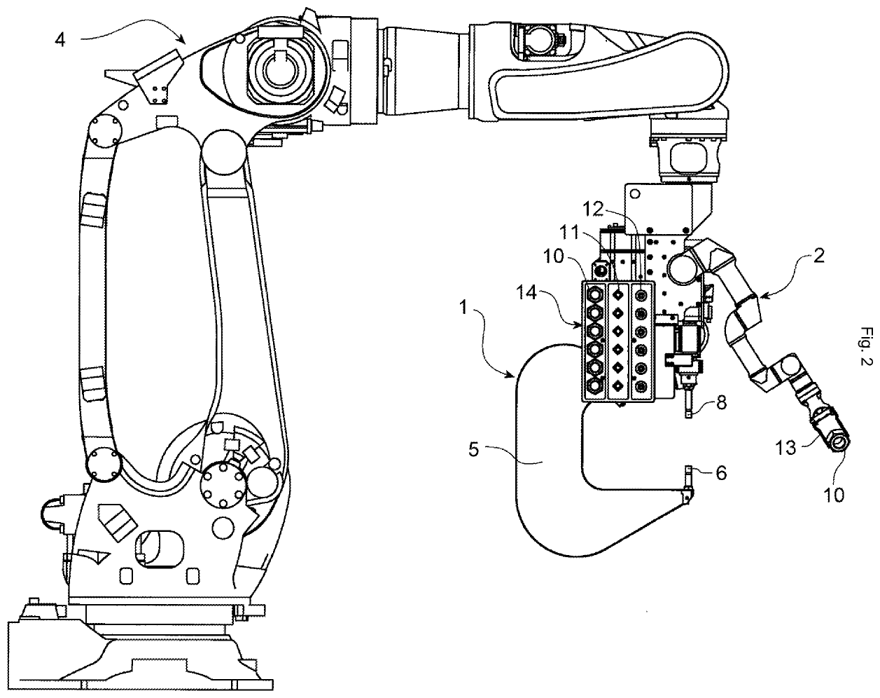

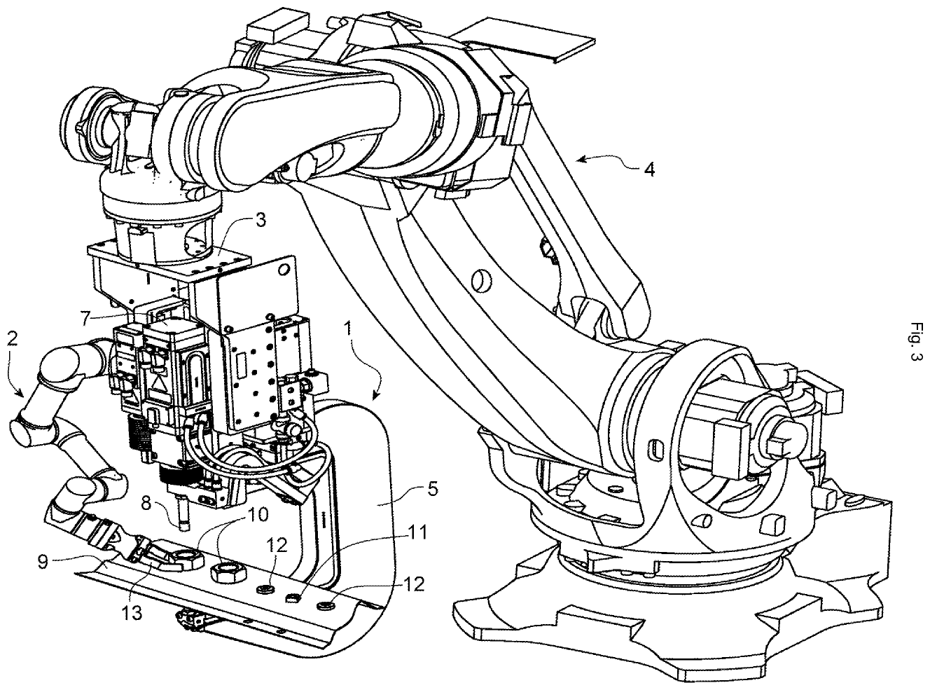

FIG. 1 shows a welding gun 1 according to the system described herein with a six-axis robot arm 2. The welding gun 1 has a mounting plate 3 which forms a mounting element with which the welding gun 1 is screwed to an industrial robot 4 (see FIG. 2 and FIG. 3). The industrial robot 4 may be a six-axis robot arm having the mounting plate 3 is screwed to a free end of the six-axis robot arm of the industrial robot 4. FIG. 1 only shows two front jointed links of the arm of the industrial robot 4. The arm of the industrial robot 4 constitutes a positioning device that moves the welding gun 1 into processing positions at a workpiece.

The welding gun 1 is a so-called C-type gun having a rigid C-shaped welding arm 5, which carries a fixed welding electrode 6 (a lower electrode in the drawings). At an opposite end of the welding arm 5, an electrode drive 7 is provided, which carries a movable electrode 8 in an axially displaceable manner. The top and bottom orientations only apply to the orientation of the welding gun 1 in the drawings. Since the welding gun 1 is held by the arm of the industrial robot 4, the welding gun 1 can assume any orientation and position in space.

It should be noted that the present invention is not limited to the type of welding gun shown in the drawings. Another widely used type of welding gun for resistance welding is an X-type gun. Here too, the multi-axis arm of the robot 4 may be attached to the housing of the X-type gun or to the mounting plate 3. It is also possible to attach other types of welding guns and/or manufacturing tools other than welding guns to the arm of the robot 4.

FIG. 1 and FIG. 3 show the welding gun 1 during operation on a workpiece to be processed, in this case a profiled sheet 9. The welding gun 1 is used to weld various components onto the profiled sheet 9, in the example shown, hexagonal weld nuts 10, square nuts 11 and ring-shaped weld nuts 12. Any components that are used are of course selected at will and may be designed differently depending on any requirements of the production process.

A manipulator, such as a gripper 13, may be arranged at the end of the multi-axis robot arm 2. In FIG. 2, it can be seen that a magazine 14, which constitutes a holding device for the components 10-12 to be mounted, is arranged on the side of the welding gun 1 to which the multi-axis robot arm 2 is attached. FIG. 2 shows that a vertical row of six hexagonal weld nuts 10, located one below the other, is arranged in a left third of the magazine 14. In a center of the magazine 14, a vertical row of six square weld nuts 11, located one below the other, is arranged. In the right-hand third of the magazine 14, a vertical row of six ring-shaped weld nuts, located one below the other, is arranged. The magazine 14 may have a magnetic base plate so that the components 10-12 that are pushed onto corresponding holding bolts are held magnetically when the welding gun 1 is moved and do not disengage from the magazine 14. The gripper 13 may grip one of the components 10, 11, 12 held by the magazine 14 and move the one of the components 10, 11, 12 into the desired position so that the manufacturing tool, i.e. the welding gun 1, can weld the one of the components 10, 11, 12 in place.

After the workpiece to be processed, in the drawings the profiled sheet 9, has been completely processed, the welding gun 1 can be moved away from the workpiece 9. Preferably, the welding gun 1 is moved into a rest position in which the gripper 13 can grip new ones of the components 10, 11, 12 from predetermined transfer points (not shown) and attach the new ones of the components 10, 11, 12 to the magazine 14. Alternatively, the gripper 13 can disengage the entire magazine 14 from the welding gun 1 and attach a new magazine (not shown) and transfer new ones of the components 10, 11, 12 to be welded by the welding gun 1.

As mentioned above, the welding gun 1 as a manufacturing tool with a multi-axis robot arm attached is merely an example of an implementation of the development described herein. Other joining tools or also other manufacturing tools may be selected to which a robot arm is attached. The components to be fastened by the tool may be selected at will. A sensor, a camera, a pyrometer, an ultrasonic probe or the like may also be arranged on the multi-axis robot arm 2 instead of the manipulator 13 to check the quality of the manufacturing by the manufacturing tool.

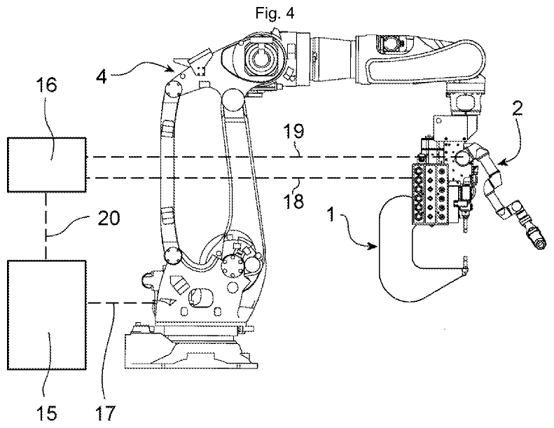

FIG. 4 schematically shows a first control unit 15 and a second control unit 16 having data links 17-20 for transmitting the control signals. The first control unit 15 is linked to an interface of the industrial robot 4 via the data link 17. The second control unit 16 is linked to the welding gun 1 via the second data link 18 and to the robot arm 2 via the third data link 19. When the control unit 16 has controlled the industrial robot 4 in such a way that the welding gun 1 is in the processing position, the control unit 16 sends a signal to the control unit 17 via the data link 20. The control unit 17 can then control the welding gun 1 via the data link 18 and the robot arm 2 via the data link 19 to attach the components 10, 11, 12 to the workpiece. The data links 18, 19 may also be combined and lead to an interface on the welding gun 1, from which the control signals are then sent both to the individual elements of the welding gun 1 and to the robot arm 2. It is also possible to use a control module (not shown) for the robot arm 2 that is separate from the control unit 16. It should be noted that the control system is only explained schematically in relation to the function of the arrangement described herein. In practice, the arrangement may further have a large number of other supply lines to ensure the function of the welding gun 1, the industrial robot 4 and the robot arm 2.

The features of the invention disclosed in the present description, in the drawings and in the claims may be essential, both individually and in any combination, for the realization of the invention in its various embodiments. The invention is not limited to the described embodiments. It may be varied within the scope of the claims and taking into account the knowledge of the relevant person skilled in the art.

1. A manufacturing tool, comprising:
a mounting element configured to be mounted on a positioning device; and
a multi-axis robot arm that is attached to the manufacturing tool.

2. The manufacturing tool according to claim 1, wherein the manufacturing tool is one of: a Welding gun; a Soldering tool; Riveting pliers; or a Screwing tool.

3. The manufacturing tool according to claim 1, wherein the positioning device is an industrial robot.

4. The manufacturing tool according to claim 1, wherein the manufacturing tool is coupled to at least one numerical control unit which controls at least one of the following: the manufacturing tool; the multi-axis robot arm; or the positioning device.

5. The manufacturing tool according to claim 4, wherein the numerical control unit is arranged remotely from the manufacturing tool and has data links configured to transmit control signals.

6. The manufacturing tool according to claim 1, further comprising:
a manipulator that is attached to the multi-axis robot arm.

7. The manufacturing tool according to claim 1, further comprising:
a holding device configured to hold at least one component.

8. A method for joining a component using a manufacturing tool which has a mounting element mounted to a positioning device, comprising:
moving the manufacturing tool into a processing position using the positioning device;
a multi-axis robot arm that is fastened to the manufacturing tool moving at least one component into a joining position; and
the manufacturing tool fastening the component after moving the at least one component into the joining position.

9. Method The method according to claim 8, further comprising:
the robot arm removing the at least one component from a holding device attached to the manufacturing tool.

10. Method The method according to claim 9, wherein the robot arm removes the at least one component from a supply and attaches the at least one component to the holding device.

11. The manufacturing tool according to claim 3, wherein the manufacturing tool is coupled to at least one numerical control unit which controls at least one of the following: the manufacturing tool; the multi-axis robot arm; or the positioning device.

12. The manufacturing tool according to claim 11, wherein the numerical control unit is arranged remotely from the manufacturing tool and has data links that transmit control signals.

13. The manufacturing tool according to claim 12, further comprising:
a manipulator that is attached to the multi-axis robot arm.

14. The manufacturing tool according to claim 13, further comprising:
a holding device configured to hold at least one component.

15. The method according to claim 8, wherein the positioning device is an industrial robot.

16. The method according to claim 8, wherein the manufacturing tool is one of: a Welding gun; a Soldering tool; Riveting pliers; or a Screwing tool.

17. The method according to claim 8, wherein the manufacturing tool is coupled to at least one numerical control unit which controls at least one of the following: the manufacturing tool; the multi-axis robot arm; or the positioning device.

18. The method according to claim 17, wherein the numerical control unit is arranged remotely from the manufacturing tool and has data links configured to transmit control signals.

19. The method according to claim 18, further comprising:
a manipulator, attached to the multi-axis robot arm, manipulating at least one component.

20. The method according to claim 19, further comprising:
a holding device configured to hold the at least one component after the at least one component has been manipulated by the manipulator.
